(19) United States
(12) Patent Application Publication
(10) Pub. No.: US 2013/0028150 A1
(43) Pub. Date: Jan. 31, 2013

(54) Method and System for Wireless Communication in Multiple Operating Environments

(71) Applicants: Jianglei Ma, Ottawa (CA); Mo-Han Fong, L'Original (CA); Hang Zhang, Nepean (CA); Jun Li, Richardson, TX (US); Ming Jia, Ottawa (CA); Peiying Zhu, Kanata (CA); Wen Tong, Ottawa (CA)

(72) Inventors: Jianglei Ma, Ottawa (CA); Mo-Han Fong, L'Original (CA); Hang Zhang, Nepean (CA); Jun Li, Richardson, TX (US); Ming Jia, Ottawa (CA); Peiying Zhu, Kanata (CA); Wen Tong, Ottawa (CA)

(73) Assignee: Research In Motion Limited, Waterloo (CA)

(21) Appl. No.: 13/620,746

(22) Filed: Sep. 15, 2012

Related U.S. Application Data
(63) Continuation of application No. 11/835,666, filed on Aug. 8, 2007.
(60) Provisional application No. 60/836,139, filed on Aug. 8, 2006.

(51) Int. Cl. H04W 88/06; H04W 72/04

(52) U.S. Cl. 370/280; 370/310; 370/328

(57) ABSTRACT

A wireless communication method and system are provided. A first wireless communication numerology, e.g., OFDM operating parameters, corresponding to a first operational mode is established. A second wireless communication numerology corresponding to a second operational mode is also established. The first wireless communication numerology is different than the second wireless communication numerology. One of the first operational mode and the second operational mode is selected. One of the first wireless communication numerology and the second wireless communication numerology corresponding to the selected operational mode is used in which communication in the first operational mode and the second operational mode use substantially similar synchronization channels. The present invention also uses the same superframe structure for the first and second operational modes for Ultra-Mobile Broadband (“UMB”) networks and the same frame structure for the first and second operational modes for Long Term Evolution (“LTE”) networks.

### CROSS-REFERENCE TO RELATED APPLICATION

This application is related to and claims priority to U.S. Provisional Application Ser. No. 60/836,139, filed Aug. 8, 2006, entitled Numerology for Indoor Application, the entirety of which is incorporated herein by reference.

### STATEMENT REGARDING FEDERALLY SPONSORED RESEARCH OR DEVELOPMENT

n/a

### FIELD OF THE INVENTION

The present invention relates to wireless network communications and particular to a method and system for increasing wireless communication network spectral efficiency for mobile stations operating in multiple environments, such as indoor and outdoor and/or time division duplex having different uplink and downlink transmission ratios.

### BACKGROUND OF THE INVENTION

Wireless communication networks, such as cellular networks, operate by sharing resources among the mobile terminals operating in the communication network. As part of the sharing process, resources relating to which channels, codes, etc., are allocated by one or more controlling devices within the system. Certain types of wireless communication networks, e.g., orthogonal frequency division multiplexed (“OFDM”) networks, are used to support cell-based high speed services such as those under certain standards such as the 3rd Generation Partnership Project (“3GPP”) and 3GPP2 evolutions, e.g., Long Term Evolution (“LTE”), the Ultra-Mobile Broadband (“UMB”) broadband wireless standard and the IEEE 802.16 standards. The IEEE 802.16 standards are often referred to as WiMAX or less commonly as WirelessMAN or the Air Interface Standard.

OFDM technology uses a channelized approach and divides a wireless communication channel into many sub-channels which can be used by multiple mobile terminals at the same time. These sub-channels and hence the mobile terminals can be subject to interference from adjacent cells because neighboring base stations can use the same frequency blocks. Interference can also result from inter-symbol interference such as can result when wireless communication signals are reflected off surfaces such as walls, building exteriors, mountains, etc. While techniques for reducing susceptibility to these interferences are known, these techniques employ methods which establish operating parameters (also referred to as “numerology”), such as cyclic prefix (“CP”) length and fast fourier transform (“FFT”) length based on the expected worst case operating environment. The result is that spectral efficiency is reduced, thereby reducing both communication throughput as well as the quantity of mobile terminals that can be supported in the network.

As an example, consider the situation where a mobile terminal is operable in different environments, such as indoors and outdoors. In this case, in order to provide communications in both environments, a base station will typically establish numerology based on the expected worst case operation, namely the outdoor operation. The result is that, because the propagation conditions in the indoor environment are different, spectral efficiency suffers when the mobile terminal is operated indoors. For example, the shorter delay spread resulting from inter-symbol interference allows for a shortened CP when indoors. Also, because mobile terminals operating indoors tend to be stationary or at worst, nomadic (slow moving), narrower sub-carrier spacing can be used indoors when compared with the wider sub-carrier spacing used for outdoor operation. It is therefore desirable to have a system and method that allows efficient operation of a mobile station in different operating environments in a manner that causes as little adverse impact to the operation of the mobile terminal, e.g., the handoff between different modes corresponding to different operating environments, initial access time, neighbor cell searching, signal processing complexity, etc., as possible.

In addition to indoor and outdoor operating environments, mobile terminals may also need to operate using different duplex modes. For example, a mobile terminal may need to operate using frequency division duplex (“FDD”) communications or time division duplex (“TDD”) division communications. In FDD communications, the transmit and receive channels are separated by a guard band and use different frequency spectrums. In TDD communications, one channel is used for transmitting and receiving, but different time slots within the channel are used for transmission and receipt. No guard band is used for TDD communications.

A mobile terminal can be used for either TDD or FDD communications. However, numerologies for the OFDM communications can differ between TDD and FDD operation. For example, while guard bands are not used in TDD communications, the transition guard time between the uplink (“UL”), i.e., from mobile terminal to base station, and downlink (“DL”), i.e., from base station to mobile terminal, and the transition time between DL transmission and UL transmission are required. Also, multiple ratios between DL transmission duration and UL transmission duration should be supported.

In addition, in some existing arrangements, the superframe (in the case of UMB duration for TDD is different from that of FDD. As noted above, the ratios between DL and UL can also differ. Supporting multiple superframe definitions makes the initial cell access and the cell searching (for example, in connected and idle modes) more difficult, requiring more search time and higher complexity. It is therefore further desirable to have a method and system that allows a superframe (or frame) and numerology arrangement which facilitates multi-mode operation without requiring complex and expensive mobile terminal implementations and without adversely impacting performance.

### SUMMARY OF THE INVENTION

The present invention advantageously provides a method and system for wireless communication that supports operation in multiple modes, e.g., indoor/outdoor, TDD/FDD, etc., by using different numerologies, such as OFDM numerologies, to support the different modes.

In accordance with one aspect, the present invention provides a method for wireless communication in which a first wireless communication numerology, e.g., OFDM operating parameters, corresponding to a first operational mode is established. A second wireless communication numerology corresponding to a second operational mode is also established. The first wireless communication numerology is different than the second wireless communication numerology. One of the first operational mode and the second operational mode is selected. One of the first wireless communication numerology and the second wireless communication numerology corresponding the selected operational mode is used in which communication in the first operational mode and the second operational mode use substantially similar initial access channels.

In accordance with another aspect, the present invention provides a wireless communication system having a base station. The base station stores a first wireless communication numerology corresponding to a first operational mode. The base station also stores a second wireless communication numerology corresponding to a second operational mode. The first wireless communication numerology is different than the second wireless communication numerology. The base station selects one of the first operational mode and the second operational mode. Communication in the first operational mode and the second operational mode uses substantially similar initial access channels.

In accordance with still another aspect, the present invention provides a method for wireless communication using a time division duplex (“TDD”) frame having a plurality of TDD slots for TDD communication. The plurality of TDD slots are arranged into uplink TDD slots and downlink TDD slots. The TDD frame has a synchronous transmission period in which the boundaries of downlink transmission and uplink transmission TDD slots are aligned among base stations and an asynchronous transmission period. A type of TDD uplink and downlink transmission slot arrangement from all available channel allocation schemes is selected for transmission during the asynchronous transmission period.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an embodiment of a system constructed in accordance with the principles of the present invention;

FIG. 2 is a block diagram of an exemplary base station constructed in accordance with the principles of the present invention;

FIG. 3 is a block diagram of an exemplary mobile terminal constructed in accordance with the principles of the present invention;

FIG. 4 is a block diagram of an exemplary OFDM architecture constructed in accordance with the principles of the present invention;

FIG. 5 is a block diagram of the flow of received signal processing in accordance with the principles of the present invention;

FIG. 6 is a diagram of an exemplary scattering of pilot symbols among available sub-carriers;

FIG. 7 is a diagram of exemplary superframe arrangements for indoor and outdoor modes of operation;

FIG. 8 is a diagram of another pair of exemplary superframe arrangements for indoor and outdoor modes of operation;

FIG. 9 is a diagram of yet another pair of exemplary superframe arrangements for indoor and outdoor modes of operation;

FIG. 10 is a diagram of still another pair of exemplary superframe arrangements for indoor and outdoor modes of operation;

FIG. 11 is a diagram of an exemplary super-frame arrangements for TDD and FDD modes of operation;

FIG. 12 is a diagram of another pair of exemplary superframe arrangements for TDD and FDD modes of operation; and

FIG. 13 is a diagram of exemplary frame arrangements for asynchronous TDD modes of operation in which the ratio of downlink to uplink symbols changes.

### DETAILED DESCRIPTION OF THE INVENTION

As an initial matter, while certain embodiments are discussed in the context of wireless networks operating in accordance with the Ultra-Mobile Broadband (“UMB”) broadband wireless standard, which is hereby incorporated by reference, the invention is not limited in this regard and may be applicable to other broadband networks including those operating in accordance with other OFDM orthogonal frequency division (“OFDM”)-based systems including other WiMAX (MEE 802.16) and 3rd Generation Partnership Project (“3GPP”) evolution, e.g., Long Term Evolution (“LTE”), etc. Similarly, the present invention is not limited solely to OFDM-based systems and can be implemented in accordance with other system technologies, e.g., CDMA.

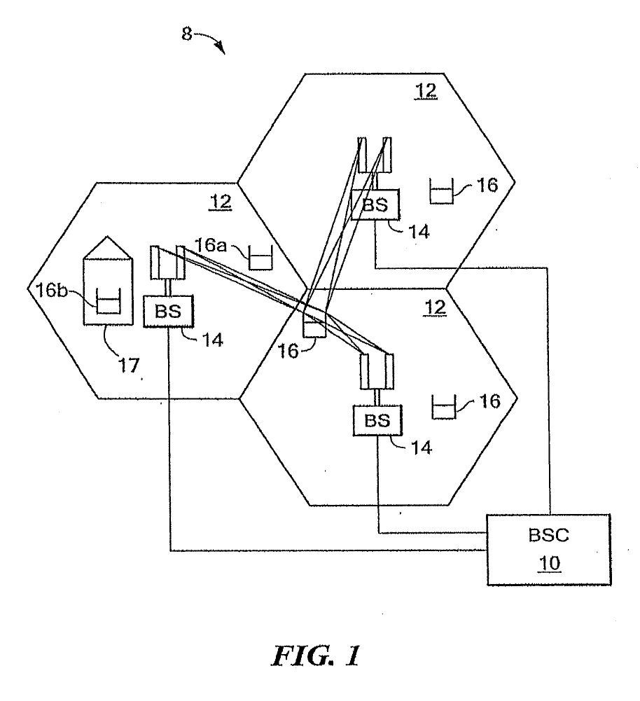

Referring now to the drawing figures in which like reference designators refer to like elements, there is shown in FIG. 1, a system constructed in accordance with the principles of the present invention and designated generally as “8.” System 8 includes a base station controller (“BSC”) 10 that controls wireless communications within multiple cells 12, which are served by corresponding base stations (“BS”) 14. Although not shown, it is understood that some implementations, such LTE and WiMax, do not make use of BSC 10. In general, each base station 14 facilitates communications using OFDM with mobile terminals 16, which are illustrated as being within the geographic confines of the cell 12 associated with the corresponding base station 14. Movement of mobile terminals 16 in relation to the base stations 14 can result in significant fluctuation in channel conditions as a consequence of multipath distortion, terrain variation, reflection and/or interference caused by man-made objects (such as buildings and other structures), and so on. The movement of the mobile terminals 16 in relation to the base stations 14 results in significant fluctuation in channel conditions. As illustrated, the base stations 14 and mobile terminals 16 may include multiple antennas to provide spatial diversity for communications.

Mobile terminals 16 are operable in different environments, e.g., indoor and outdoor, and are hence operable in different modes to accommodate the channel conditions associated with these environments. As discussed below in detail, OFDM parameters, i.e., the numerology, are determined and adjusted in accordance with the operating mode. For example, mobile terminal 16a is operating in a mode suitable for outdoor use while mobile terminal 16b is operating in a mode suitable for indoor use as a result of its operation in building 17.

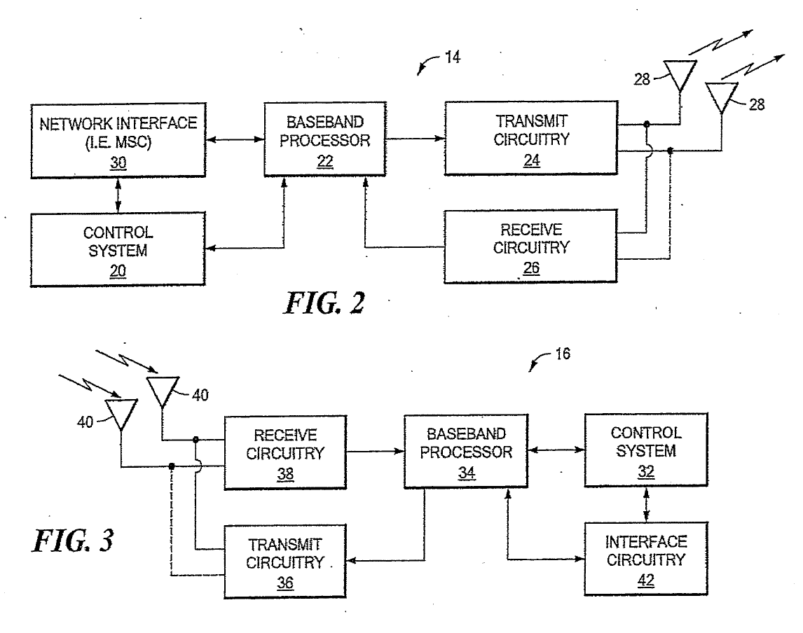

A high level overview of the mobile terminals 16 and base stations 14 of the present invention is provided prior to delving into the structural and functional details of the preferred embodiments. With reference to FIG. 2, a base station 14 configured according to one embodiment of the present invention is illustrated. The base station 14 generally includes a control system 20, a baseband processor 22, transmit circuitry 24, receive circuitry 26, multiple antennas 28, and a network interface 30. The receive circuitry 26 receives radio frequency signals bearing information from one or more remote transmitters provided by mobile terminals 16 (illustrated in FIG. 3). Preferably, a low noise amplifier and a filter (not shown) cooperate to amplify and remove out-of-band interference from the signal for processing. Down conversion and digitization circuitry (not shown) then down converts the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (“DSPs”) or application-specific integrated circuits (“ASICs”). The received information is then sent across a wireline or wireless network via the network interface 30 or transmitted to another mobile terminal 16 serviced by the base station 14.

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by a carrier signal having a desired transmit frequency or frequencies. A power amplifier (not shown) amplifies the modulated carrier signal to a level appropriate for transmission, and delivers the modulated carrier signal to the antennas 28 through a matching network (not shown). Modulation and processing details are described in greater detail below.

With reference to FIG. 3, a mobile terminal 16 configured according to one embodiment of the present invention is described. Similar to base station 14, a mobile terminal 16 constructed in accordance with the principles of the present invention includes a control system 32, a baseband processor 34, transmit circuitry 36, receive circuitry 38, multiple antennas 40, and user interface circuitry 42. The receive circuitry 38 receives radio frequency signals bearing information from one or more base stations 14. Preferably, a low noise amplifier and a filter (not shown) cooperate to amplify and remove out-of-band interference from the signal for processing. Down conversion and digitization circuitry (not shown) then down convert the filtered, received signal to an intermediate or baseband frequency signal, which is then digitized into one or more digital streams.

The baseband processor 34 processes the digitized received signal to extract the information or data bits conveyed in the received signal. This processing typically comprises demodulation, decoding, and error correction operations, as will be discussed in greater detail below. The baseband processor 34 is generally implemented in one or more digital signal processors (“DSPs”) and application specific integrated circuits (“ASICs”).

With respect to transmission, the baseband processor 34 receives digitized data, which may represent voice, data, or control information, from the control system 32, which the baseband processor 34 encodes for transmission. The encoded data is output to the transmit circuitry 36, where it is used by a modulator to modulate a carrier signal that is at a desired transmit frequency or frequencies. A power amplifier (not shown) amplifies the modulated carrier signal to a level appropriate for transmission, and delivers the modulated carrier signal to the antennas 40 through a matching network (not shown). Various modulation and processing techniques available to those skilled in the art are applicable to the present invention.

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any given carrier is lower than when a single carrier is used.

OFDM modulation is implemented, for example, through the performance of an Inverse Fast Fourier Transform (“IFFT”) on the information to be transmitted. For demodulation, a Fast Fourier Transform (“FFT”) on the received signal is performed to recover the transmitted information. In practice, the IFFT and FFT are provided by digital signal processing carrying out an Inverse Discrete Fourier Transform (IDFT) and Discrete Fourier Transform (“DFT”), respectively. Accordingly, the characterizing feature of OFDM modulation is that orthogonal carrier waves are generated for multiple bands within a transmission channel. The modulated signals are digital signals having a relatively low transmission rate and capable of staying within their respective bands. The individual carrier waves are not modulated directly by the digital signals. Instead, all carrier waves are modulated at once by IFFT processing.

In one embodiment, OFDM is used for at least the downlink transmission from the base stations 14 to the mobile terminals 16. Each base station 14 is equipped with n transmit antennas 28, and each mobile terminal 16 is equipped with m receive antennas 40. Notably, the respective antennas can be used for reception and transmission using appropriate duplexers or switches and are so labeled only for clarity.

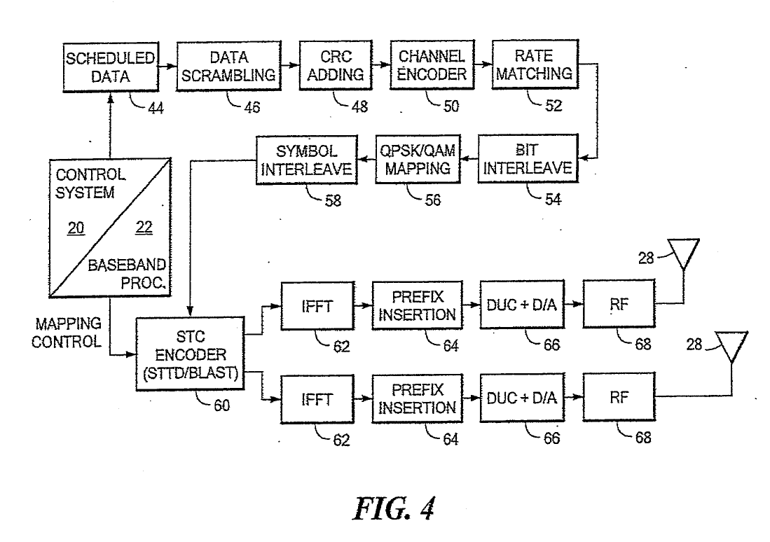

With reference to FIG. 4, a logical OFDM transmission architecture is described according to one embodiment. Initially, the base station controller 10 sends data to be transmitted to various mobile terminals 16 to the base station 14. The base station 14 may use the channel quality indicators (“CQIs”) associated with the mobile terminals to schedule the data for transmission as well as select appropriate coding and modulation for transmitting the scheduled data. The CQIs may be provided directly by the mobile terminals 16 or determined at the base station 14 based on information provided by the mobile terminals 16. In either case, the CQI for each mobile terminal 16 is a function of the degree to which the channel amplitude (or response) varies across the OFDM frequency band.

The scheduled data 44, which is a stream of bits, is scrambled in a manner reducing the peak-to-average power ratio associated with the data using data scrambling logic 46. A cyclic redundancy check (“CRC”) for the scrambled data is determined and appended to the scrambled data using CRC adding logic 48. Next, channel coding is performed using channel encoder logic 50 to effectively add redundancy to the data to facilitate recovery and error correction at the mobile terminal 16. Again, the channel coding for a particular mobile terminal 16 is based on the CQI. The channel encoder logic 50 uses known Turbo encoding techniques in one embodiment. The encoded data is then processed by rate matching logic 52 to compensate for the data expansion associated with encoding.

Bit interleaver logic 54 systematically reorders the bits in the encoded data to minimize the loss of consecutive data bits. The resultant data bits are systematically mapped into corresponding symbols depending on the chosen baseband modulation by mapping logic 56. Preferably, Quadrature Amplitude Modulation (“QAM”) or Quadrature Phase Shift Key (“QPSK”) modulation is used. The degree of modulation is preferably chosen based on the CQI for the particular mobile terminal. The symbols may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (“STC”) encoder logic 60, which modifies the symbols in a fashion making the transmitted signals more resistant to interference and more readily decoded at a mobile terminal 16. The STC encoder logic 60 will process the incoming symbols and provide n outputs corresponding to the number of transmit antennas 28 for the base station 14. The control system 20 and/or baseband processor 22 will provide a mapping control signal to control STC encoding. At this point, assume the symbols for the n outputs are representative of the data to be transmitted and capable of being recovered by the mobile terminal 16. See A. F. Naguib, N. Seshadri, and A. R. Calderbank, “Applications of space-time codes and interference suppression for high capacity and high data rate wireless systems,” Thirty-Second Asilomar Conference on Signals, Systems & Computers, Volume 2, pp. 1803-1810, 1998, which is incorporated herein by reference in its entirety.

For the present example, assume the base station 14 has two antennas 28 (n=2) and the STC encoder logic 60 provides two output streams of symbols. Accordingly, each of the symbol streams output by the STC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols to provide an inverse Fourier Transform. The output of the IFFT processors 62 provides symbols in the time domain. The time domain symbols are grouped into frames, which are associated with a prefix by like insertion logic 64. Each of the resultant signals is up-converted in the digital domain to an intermediate frequency and converted to an analog signal via the corresponding digital up-conversion (DUC) and digital-to-analog (D/A) conversion circuitry 66. The resultant (analog) signals are then simultaneously modulated at the desired RF frequency, amplified, and transmitted via the RF circuitry 68 and antennas 28. Notably, pilot signals known by the intended mobile terminal 16 are scattered among the sub-carriers. The mobile terminal 16, which is discussed in detail below, will use the pilot signals for channel estimation.

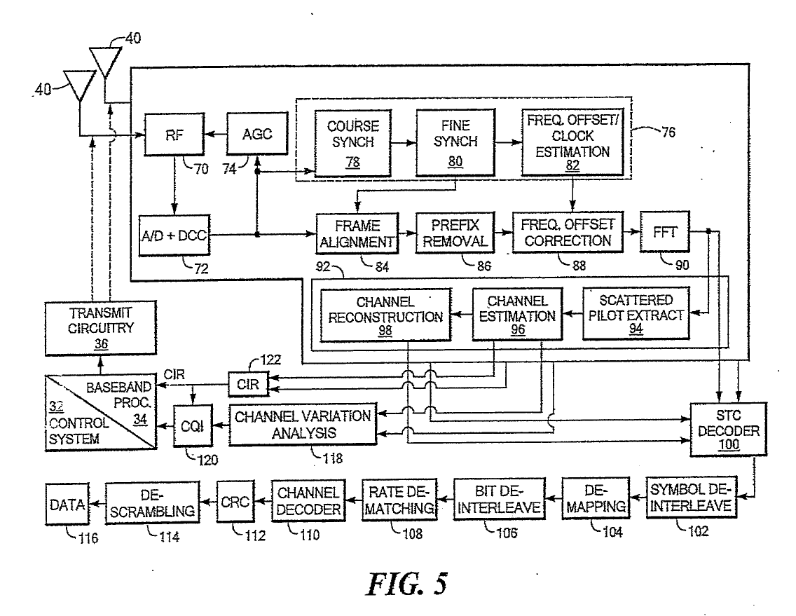

Reference is now made to FIG. 5 to illustrate reception of the transmitted signals by a mobile terminal 16. Upon arrival of the transmitted signals at each of the antennas 40 of the mobile terminal 16, the respective signals are demodulated and amplified by corresponding RF circuitry 70. For the sake of conciseness and clarity, only one of the receive paths is described and illustrated in detail, it being understood that a receive path exists for each antenna 40. Analog-to-digital (“A/D”) converter and down-conversion circuitry 72 digitizes and downconverts the analog signal for digital processing. The resultant digitized signal may be used by automatic gain control circuitry (“AGC”) 74 to control the gain of the amplifiers in the RF circuitry 70 based on the received signal level.

Initially, the digitized signal is provided to synchronization logic 76, which includes coarse synchronization logic 78, which buffers several OFDM symbols and calculates an auto-correlation between the two successive OFDM symbols. A resultant time index corresponding to the maximum of the correlation result determines a fine synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent FFT processing provides an accurate conversion from the time to the frequency domain. The fine synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

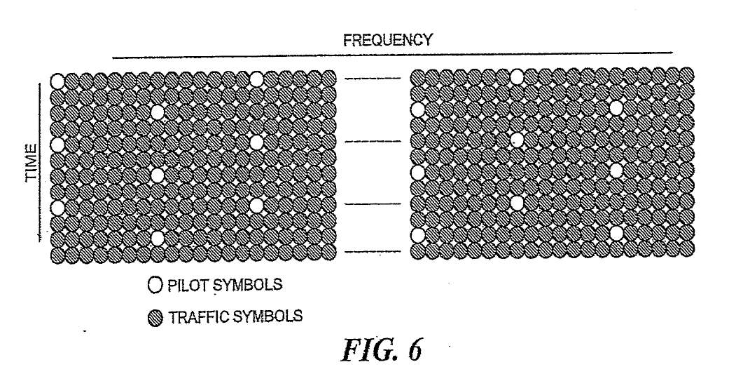

At this point, the OFDM symbols in the time domain are ready for conversion to the frequency domain using FFT processing logic 90. The results are frequency domain symbols, which are sent to processing logic 92. The processing logic 92 extracts the scattered pilot signal using scattered pilot extraction logic 94, determines a channel estimate based on the extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. FIG. 6 illustrates an exemplary scattering of pilot symbols among available sub-carriers over a given time and frequency plot in an OFDM environment. Referring again to FIG. 5, the processing logic compares the received pilot symbols with the pilot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual and interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides STC decoding on both received paths to recover the transmitted symbols. The channel reconstruction information provides equalization information to the STC decoder 100 sufficient to remove the effects of the transmission channel when processing the respective frequency domain symbols

The recovered symbols are placed back in order using symbol de-interleaver logic 102, which corresponds to the symbol interleaver logic 58 of the transmitter. The de-interleaved symbols are then demodulated or de-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for de-scrambling using the known base station de-scrambling code to recover the originally transmitted data 116.

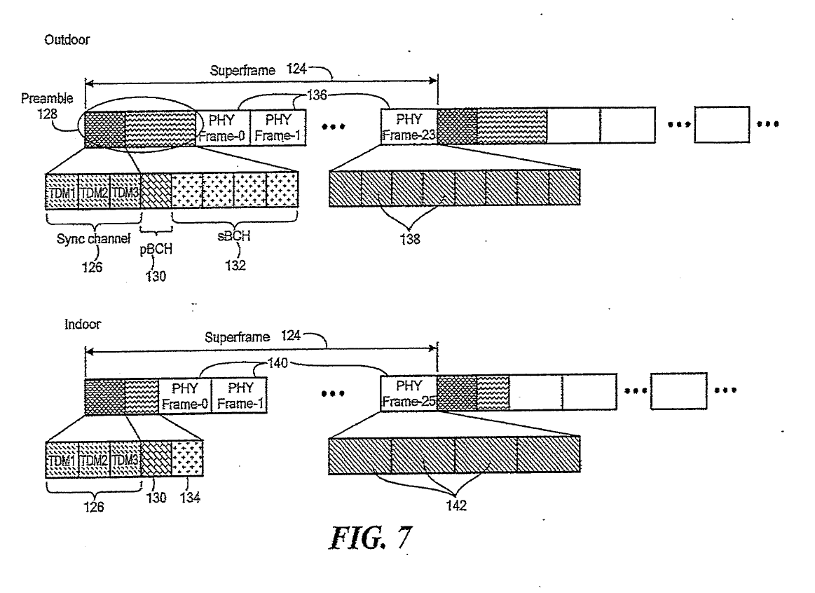

Support for multiple operating modes in the same wireless system is described with reference to FIGS. 7-10. The embodiments shown in FIGS. 7-10 minimize the handoff processing requirements between two different numerologies; keeping the same basic superframe (or frame) structure while using different CP sizes to minimize overhead. This arrangement advantageously optimizes parameters for the various modes of operation. Of note, although the present invention is described with reference to two modes of operation, such as indoor and outdoor modes of operation, it is understood that the present invention can be readily expanded to more than two modes corresponding to more than two propagation environments.

The use of different CP sizes minimizes operational overhead within each different operating environment. Using the same sampling frequency provides the same superframe length regardless of operational mode. As shown in FIGS. 7-10, use of the same sampling frequency for indoor and outdoor use results in the same superframe 124 length. Use of the same sampling frequency allows for a simplified hardware implementation for mobile terminal 16.

Also, as shown in FIGS. 7-10, the present invention contemplates the use of the same initial access channels, for example, synchronization (“sync”) channels, for indoor and outdoor use. Such is the case because base station 14 and mobile station 16 do not know, upon initialization, whether mobile terminal 16 is operating indoors or outdoors. In other words, the initial access channel, shown for example as sync channel 126, is the same for indoor/outdoor operation to allow facilitate initial determination as to the operating mode. Sync channel 126 shown as part of preamble 128, includes three TDM symbols, namely, TDM1, TDM2 and TDM3. The use of the same, i.e., synchronized, sync channel provides the same symbol design for this channel at the dual operational modes, thereby simplifying cell search and providing an improved synchronization performance regardless of the mode of operation.

Regarding the similar frame structure, as is shown in the embodiment in FIG. 7, in addition to using the same initial access channel, e.g., sync channel 126, all modes of operation use the same primary broadcast channel (“pBCH”) 130. Further, the similar frame structure between the indoor and outdoor operational modes advantageously allows N OFDM symbols where N is different for each mode of operation. For example, while the frame structure is similar, N can equal 8 for outdoor operation and N can equal 4 for indoor operation. The different number of symbols results from the use of different FFT sizes, different CP sizes or a combination of the two for the different modes of operation.

In accordance with the present invention, different broadcast symbols for the secondary broadcast channel (“sBCH”) and data symbols are implemented based on the operational mode. This is accomplished by using different FFT sizes and/or different CP lengths, or a combination of the two, for the different modes of operation. The number of broadcast symbols in the sBCH portion of the preamble can be different between the modes of operation or can be the same. The embodiment shown in FIG. 7, provides a four symbol sBCH 132 for outdoor operation but only a single sBCH 134 for indoor operation.

In operation, pBCH 130 is used to provide static information which typically includes information used to decode other channels such as system bandwidth, CP length, DL/UL transmission ratio (in the case of TDD operation), base station 14 antenna configuration, and the like. The sBCH is used to broadcast dynamic information. As shown in FIG. 7, because less sBCH information is used for indoor operation, sBCH 134 is smaller than sBCH 132, i.e., one symbol for indoor operation and four symbols for outdoor operation. Such is the case to ensure that the super-frame size and the PHY frame sizes for data transmission are the same. After assigning three OFDM symbols to sync and one OFDM symbol to sBCH, the leftover OFDM symbol numbers are different for the outdoor and indoor modes of operation. It is also noted that the pilot densities can be different for the different modes of operation.

The embodiment shown in FIG. 7 shows 24 physical (“PHY”) frames 136 each having eight (N=8) OFDM symbols 138. In contrast, for indoor use, FIG. 7 shows 25 PHY frames 140, each having four (N=4) OFDM symbols 142. As noted above, the symbol duration is based on the FFT size. Different CP lengths and different FFT sizes result in the different number of PHY frames. Accordingly, doubling the FFT size as is shown between outdoor mode and the indoor mode in FIGS. 7-10 results in a doubling of the symbol duration in the time domain. This results in lowering the overhead of the CP duration as a percentage of the symbol duration, thereby allowing for efficient operation indoors. The present invention therefore advantageously allows the FFT and CP to change for indoor operation where mobile terminal 16 is typically slow moving, if it is even moving at all, thereby allowing more efficient spectral operation indoor as compared with outdoor operation. The present invention therefore advantageously allows mobile terminal 16 to avoid establishing FFT and CP size based solely on the worst expected operating environment, e.g., outdoor only.

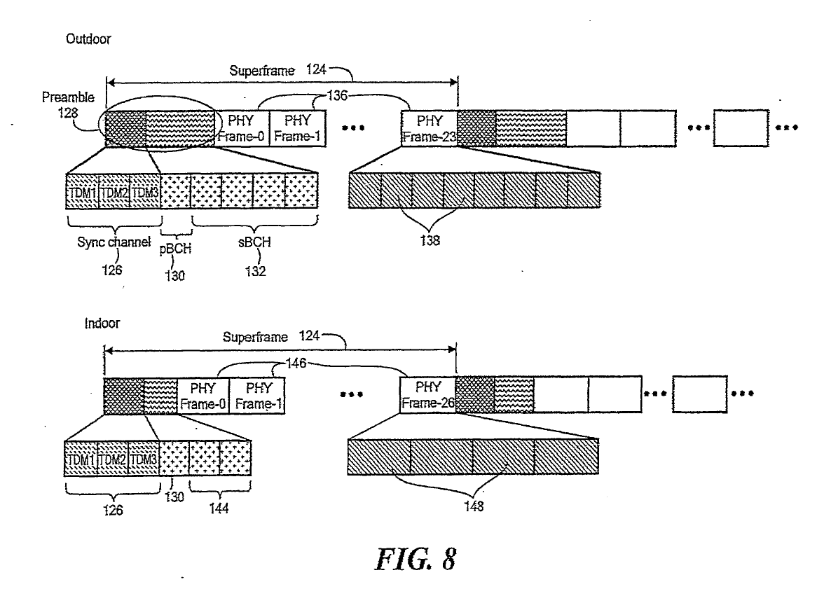

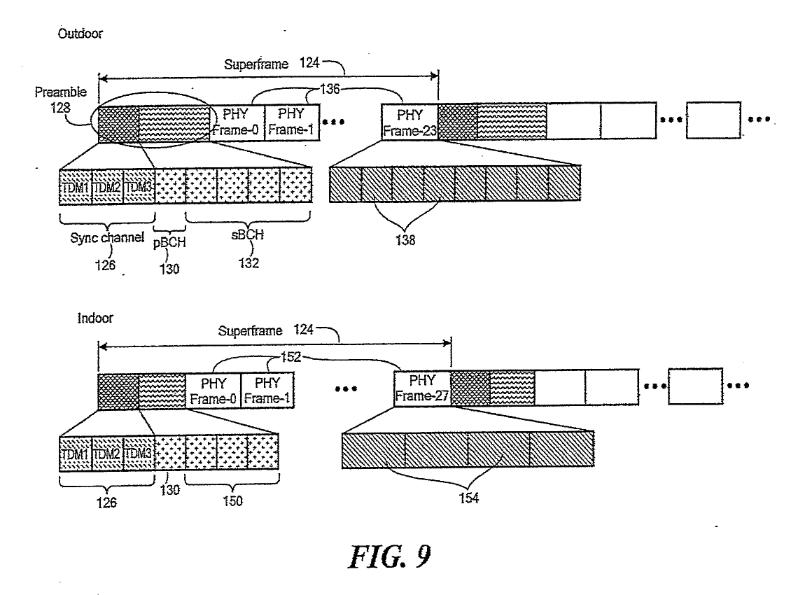

Low mobility speed such as typically occurs in indoor operation means that narrow carrier spacing can be used as compared with outdoor operation. This means that a larger FFT can be used allowing larger symbol duration and more efficient spectral use indoors. FIG. 8 shows another embodiment of the implementation of FFT and CP and preamble sizes for the present invention. As shown in FIG. 8, while sBCH 132 for outdoor operation includes four symbols, sBCH 144 for indoor operation is two symbols. Also while the outdoor superframe 124 includes 24 PHY frames 136, superframe 124 space for outdoor use includes 27 PHY frames 146. However, like the embodiment shown on FIG. 7, outdoor mode includes eight OFDM symbols 138 per PHY frame, and outdoor PHY frames include four OFDM symbols. Accordingly, while the number of OFDM symbols is the same between the outdoor embodiments in FIGS. 8 and 9, the OFDM symbol duration is different, thereby, resulting in a different number of PHY frames.

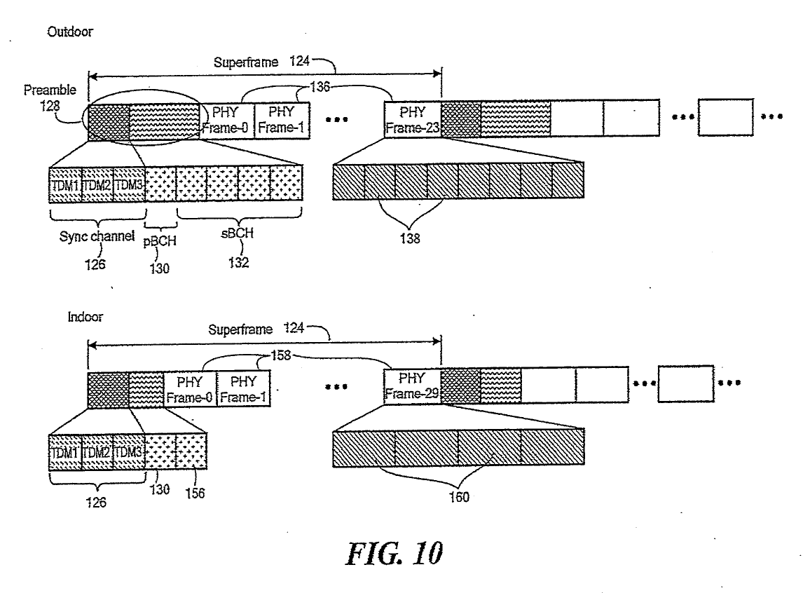

This arrangement is further exemplified in FIGS. 9 and 10 which show still two additional embodiments. As shown in FIGS. 9 and 10, the superframe and frame arrangements for the outdoor mode of operation are the same as those shown in FIGS. 7 and 8. However, the arrangement shown in FIG. 9 includes three sBCH symbols 150 for indoor use and includes 28 PHY frames 152 in indoor superframe 124. As with the embodiments shown in FIGS. 7 and 8, the embodiment shown in FIG. 9 includes four OFDM symbols, shown as OFDM symbols 154, in each PHY frame, the difference being the OFDM symbol duration resulting from different CP lengths used to provide 28 PHY frames 152 as compared with the embodiments shown in FIGS. 7 and 8.

The still different embodiment shown in FIG. 10 includes a single sBCH symbol 156 at the outdoor superframe 124 and 30 PHY frames 158 in the outdoor mode superframe 124. As with the embodiment shown in FIGS. 7-9, each PHY frame includes four OFDM symbols, shown in FIG. 10 as OFDM symbols 160. As with the other embodiments, CP size and/or OFDM symbol duration is adjusted from outdoor to indoor mode to accommodate the 30 PHY frames 158 in superframe 124 and the quantity of sBCH symbols in the outdoor mode preamble is adjusted based on the broadcast information that needs to be conveyed during indoor operation.

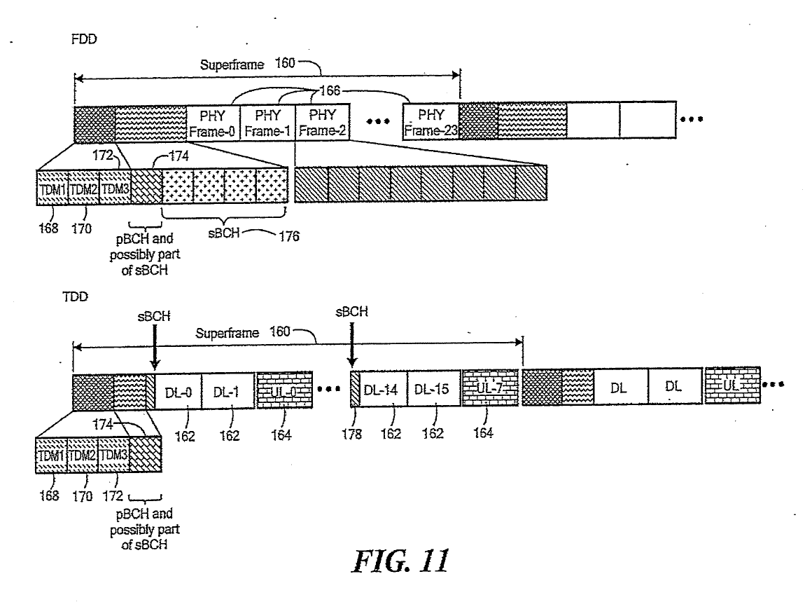

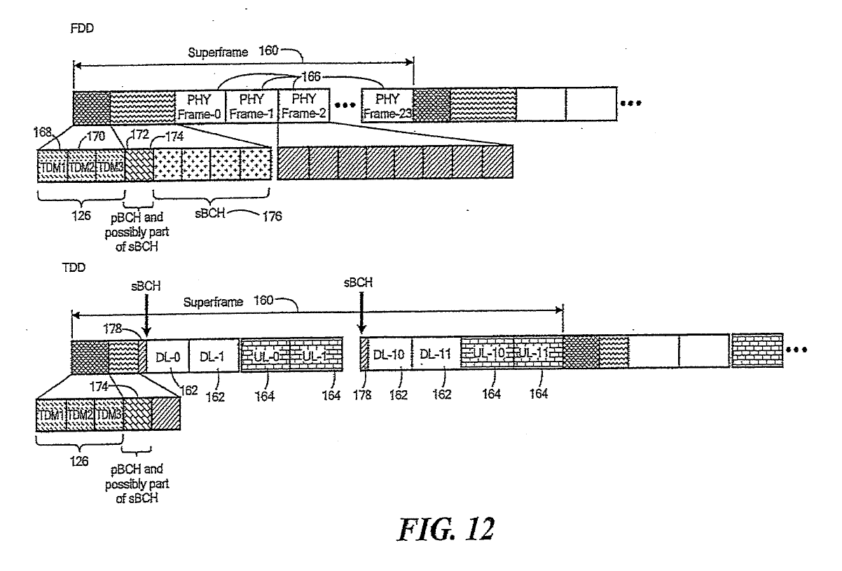

Another aspect of the present invention supports multiple operation modes with respect to TDD and FDD modes and also considers the situation where the UL/DL ratio changes in TDD operation. This aspect of the present invention is described with reference to FIGS. 11 and 12. As with indoor/outdoor operation described above, the FDD and TDD modes of operation employ a single superframe definition. Also, with the indoor and outdoor modes of operation, although the FDD and TDD modes of operation described with reference to FIGS. 11 and 12 show a single superframe with respect to UMB systems, it is understood that the present arrangement is readily implementable in a frame/sub-frame environment such as LTE.

In general, with respect to a first embodiment for FDD and TDD operation, in addition to maintaining the same superframe duration, the same superframe duration is maintained for differing TDD uplink and downlink ratios. Further, the first embodiment allows various preamble lengths in which the preamble includes synchronization and cell search channels as well as a broadcast channel. This arrangement advantageously provides the same initial access, e.g., synchronization and cell search channel, structure for FDD and TDD operation. As with the indoor and outdoor modes discussed above, the same primary channel structure is used for FDD and TDD operation, while the invention is flexible enough to allow different secondary broadcast channel structures between FDD and TDD operation. This first embodiment therefore provides an efficient mechanism for handoff to and from TDD and FDD modes while reducing initial access complexity.

In accordance with a second embodiment, the superframe duration is maintained and is the same for different TDD uplink and downlink ratios. Similarly, the preamble length and structure is fixed for these different TDD uplink and downlink ratios. As with the first embodiment, the preamble includes a synchronization and cell search channel, as well as a broadcast channel. The same synchronization and cell search channel structure is used between the different modes, i.e., different TDD uplink and downlink ratio modes. The same primary broadcast channel structure is used between the two different modes as well. However, unlike the embodiment discussed above, the same or different secondary broadcast channel structure can be used in the second embodiment to support operation in the different TDD uplink and downlink ratio environments.

FIG. 11 is a frame diagram corresponding to the first embodiment described above in which the superframe structure for FDD and TDD is the same, and in which the TDD uplink/downlink ratio is 2:1 and sBCH transmission is distributed. FIG. 12 also corresponds to the first embodiment and shows a superframe structure for FDD and TDD operation in which the TDD UL/DL ratio is 2:2 and sBCH transmission is distributed.

In accordance with this embodiment, as noted above, the superframe duration for TDD and FDD modes is the same regardless of the TDD UL/DL ratio. In accordance with this embodiment, the same PHY frame structure is used, as is the same synchronization and cell search channel. In accordance with this embodiment, the total number of PHY frames can be the same or different for TDD and FDD modes. System 8 in accordance with this embodiment supports TDD M:N modes for general values of M and N where M:N refers to the time-partitioning between the uplink and downlink. M consecutive downlink PHY frames alternate with N consecutive PHY frames. Accordingly, referring to FIG. 11, in a 2:1 ratio environment, superframe 160 in the TDD mode includes two downlink frames 162 followed by a single uplink frame 164. Each PHY frame 166 in the FDD superframe 160 includes K OFDM symbols. The transition durations (or guard time intervals) from downlink transmission to uplink transmission and from uplink transmission to downlink transmission are generated from part of the broadcast channel. The leftover broadcast content is transmitted using predetermined reserved resources in DL PHY frames. Of note, although not shown, downlink frames 162 and uplink frames 164 are PHY frames.

As noted above, the synchronization channels for FDD and TDD modes of operation are the same. As shown in FIGS. 11 and 12, with respect to UMB, the first N, for example N=3, OFDM symbols in each superframe 160 are used as the synchronization channel 126. The first symbol, TDM1 168, is used to transmit the forward acquisition channel and the second symbol, TDM2 170, and the third symbol, TDM3 172, are used to transmit the cell identification channel.

The broadcast channel includes pBCH 174 and sBCH 176 for FDD mode and sBCH 178 for TDD mode. pBCH 174 is used to transmit static system information to decode the secondary broadcast channel and/or part of the quick paging channel, pBCH 174 is typically the OFDM symbol transmitted immediately following the synchronization channel 126. sBCH 176 and 178 are used to transmit the remaining broadcast information and also the quick paging information. sBCH can be transmitted by the remaining OFDM symbols in the preamble and/or a reserved channel resource in some PHY frames 162, 164, 166.

With respect to transmitting any remaining content of sBCH on a reserve channel resource in PHY frames, two options are contemplated. First, sBCH transmission can be distributed. Second, sBCH transmission can be contiguous.

Regarding distributed sBCH transmission, to balance the traffic channel resources in each PHY frame to support synchronous hybrid automatic repeat request (“HARQ”), the remaining content of the sBCH can be evenly distributed in every PHY frame in a superframe or evenly distributed in every PHY frame in a particular HARQ interlace in a superframe. While this may impact power saving on mobile terminal 16, the quick paging information can be transmitted in the first several PHY frames which immediately follow the preamble. Also, a bit can be transmitted in the pBCH 174 as an indicator of the updating sBCH information. As such, mobile terminal 16 that is in an idle mode only decodes the sBCH when its own content has been updated.

Regarding the second option, contiguous sBCH transmission can be implemented. For power saving purposes, the remaining content of the sBCH can be transmitted on the first N PHY frames or partial PHY frames following the preamble, where N is based on the amount of remaining sBCH content.

The resources reserved in PHY frames for sBCH transmission can be of different formats. The format used as well as the TDD ratio are typically broadcast on the pBCH 174. By way of example, with respect to different formats, one or more OFDM symbols within the PHY frame 162, 164 and/or 166 are reserved for sBCH transmission. In this case, the remaining symbols are used for regular traffic and control information transmission. With respect to a distributed resource channel (“DRCH”), the OFDM symbol that contains the polytones is not used for sBCH transmissions. In the case where a block resource channel (“BRCH”) is used, the OFDM symbol including the polytones is not used for sBCH transmission. In the alternative, the number of polytones of the BRCH tile is reduced.

As a second format, one or more DRCHs or BRCHs in the PHY frame is reserved for sBCH transmission. As still another format, one or more sub carriers in the PHY frame can be reserved for sBCH transmission. The reserved sub carriers can be contiguous, non-contiguous or a combination thereof.

In accordance with the second embodiment for multimode operation relating to TDD only in which the superframe duration is maintained for different TDD downlink/uplink ratios, the same PHY frame structure is used for the different modes. In accordance with this embodiment, system 8 supports TDD M:N modes for general values of M and N in which M:N refers to the time-partitioning ratio between downlink (M) and uplink (N). As discussed above with respect to the first embodiment, M consecutive downlink PHY frames alternate with N consecutive uplink PHY frames where each PHY frame includes K OFDM symbols. Superframe duration for the different TDD ratios is kept the same, e.g., 23.86 ms for a CP of 6.51 us. The total PHY frame quantities are the same, for example 25, for different TDD downlink/uplink ratios. In accordance with this example, each superframe includes 24 downlink and uplink PHY frames when (M plus N) is divisible by 24. Any remaining virtual PHY frames can be used as guard intervals between downlink and uplink PHY frames. In such case, all TDD ratios where (M plus N) is divisible by 24 have the same preamble structure. In other words, the same synchronization and cell search channel (TDM1, TDM2, TDM3) and the same pBCH and sBCH.

In accordance with another aspect, each superframe can include 25 downlink and uplink PHY frames where (M plus N) is divisible by 25. In this case, the guard intervals are generated using a part of the sBCH as discussed above with respect to the first embodiment. As with the embodiment discussed above, the remaining content of sBCH is transmitted on the reserved channel resource on PHY frames within the superframe. For example, where TDD ratio is 2:2, a superframe includes a superframe preamble followed by 12 downlink and 12 uplink PHY frames. Where the TDD ratio is 2:1, a superframe includes a superframe preamble followed by 16 downlink and 8 uplink PHY frames. As still another example, where the TDD ratio is 3:2, a superframe includes a superframe preamble followed by 15 downlink and 10 uplink PHY frames.

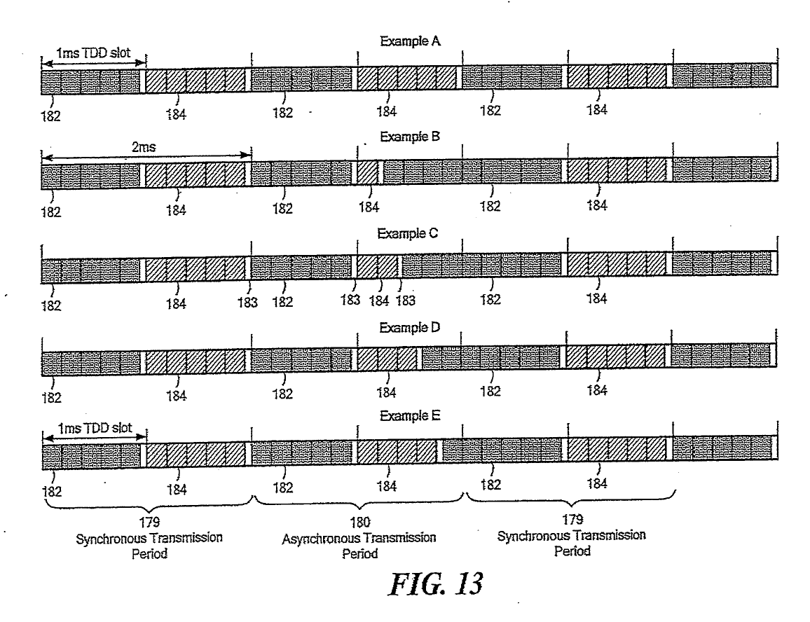

Typically, synchronous TDD is used in order to avoid interference between downlink transmission and uplink transmission. In addition, fast TDD switching can also be applied to support adaptive coding/modulation for high speed mobile terminals 16. However, in accordance with the present invention, dynamic asymmetry between the uplink and downlink can improve system capacity. In other words, in accordance with the present invention, the traffic load ratios between the downlink and uplink can change based on subscriber needs. In accordance with the present invention, TDD slots in a TDD frame can be classified into two categories. The first category is a synchronous transmission period in which the boundaries of downlink transmission and uplink transmission are aligned among all base stations 14. The second category is an asynchronous transmission period in which the base station selects one type of transmission arrangement from all available channel allocation schemes. Examples of such categorization are shown in the TDD time slot examples in FIG. 13. As is shown in FIG. 13, synchronous transmission period 179 is followed by asynchronous transmission period 180 in each of the examples.

The flexibility provided by the controlled asynchronous configuration allows dynamically asymmetric bandwidth allocation. This arrangement advantageously improves spectral efficiency and minimizes interferences caused by the asynchronous transmission. Methods to reduce the interferences between downlink transmission and uplink transmission during the asynchronous transmission period are provided by the present invention. As one example, base station 14 can apply some antenna processing methodologies, such as beamforming, to avoid interference from other base stations 14. As another example, during the asynchronous transmission period, base station 14 can schedule the uplink and downlink transmission based on channel quality measurements and uplink transmission power so that the DL and UL transmissions can be scheduled to mobile terminals 16 near the base station 14 with the reduced power.

As shown in FIG. 13, each of Examples A-E include a 2 ms synchronous transmission period in which a 1 ms TDD slot is used for downlink transmission and a 1 ms TDD slot is used for uplink transmission. In contrast, during the asynchronous transmission period, the downlink and uplink slots are variable. In FIG. 13, downlink symbols are shown as stippled boxes 182 and uplinked symbols are shown as an hatched box 184. By way of example, Example C in FIG. 13 shows, during asynchronous transmission period 180, 5 downlink symbols 182, followed by the guard time interval 183 followed by 2 uplink symbols 184, etc.

The present invention advantageously provides a method and system by which all time mode operation, such as indoor/outdoor, FDD/TDD, and variable ratio TDD modes can be supported in a spectrally efficient manner by a mobile terminal 16. One of the efficient means of support results from the use of substantially similar initial access channels in the first and second modes of operation.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A wireless communication method, comprising:
establishing a first wireless communication numerology corresponding to a first operational mode;
establishing a second wireless communication numerology corresponding to a second operational mode, the first wireless communication numerology being different than the second wireless communication numerology;
selecting one of the first operational mode and the second operational mode;
using one of the first wireless communication numerology and the second wireless communication numerology corresponding the selected operational mode, communication in the first operational mode and the second operational mode using substantially similar initial access channels.

2. The wireless communication method of claim 1, wherein the first operational mode corresponds to indoor wireless terminal operation and the second operational mode corresponds to outdoor wireless terminal operation.

3. The wireless communication method of claim 1, wherein the first operational mode corresponds to wireless terminal operation using frequency division duplex communication and the second operational mode corresponds to wireless terminal operation using time division duplex communication.

4. The wireless communication method of claim 1, wherein the first wireless communication numerology includes a first fast fourier transform (“FFT”) size and a first cyclic prefix (“CP”) value and the second wireless communication numerology includes second FFT size and a second CP value, at least one of the first FFT size and the second FFT size, and the first CP value and the second CP value being different.

5. The wireless communication method of claim 1, wherein communication in the first operational mode and the second operational mode use a same primary broadcast (“pBCH”) channel.

6. The wireless communication method of claim 5, wherein communication in the first operational mode and the second operational mode use different secondary broadcast (“sBCH”) channels.

7. The wireless communication method of claim 1, wherein a frame structure for wireless communication in the first operational mode is the same as the frame structure for wireless communication in the second operational mode.

8. The wireless communication method of claim 1, wherein a sampling frequency for communication in the first operational mode is the same as the sampling frequency for communication in the second operational mode.

9. The wireless communication method of claim 1, wherein the first operational mode is a time division duplex (“TDD”) mode having a first downlink to uplink transmission ratio and the second operational mode is a time division duplex mode having a second downlink to uplink transmission ratio, a TDD frame duration being the same for operation in the first operational mode and the second operational mode.

10. The wireless communication method of claim 9, wherein the TDD frame is comprised of a plurality of TDD slots arranged into uplink TDD slots and downlink TDD slots, the TDD frame having a synchronous transmission period in which the boundaries of downlink transmission and uplink transmission TDD slots are aligned among base stations and an asynchronous transmission period in which each base station selects a type of TDD uplink and downlink transmission slot arrangement from all available channel allocation schemes.

11. A wireless communication system, the system comprising:
a base station, the base station:
storing a first wireless communication numerology corresponding to a first operational mode;
storing a second wireless communication numerology corresponding to a second operational mode, the first wireless communication numerology being different than the second wireless communication numerology;
selecting one of the first operational mode and the second operational mode; and
using one of the first wireless communication numerology and the second wireless communication numerology corresponding the selected operational mode, communication in the first operational mode and the second operational mode using substantially similar initial access channels.

12. The wireless communication system of claim 11, wherein the first operational mode corresponds to indoor wireless terminal operation and the second operational mode corresponds to outdoor wireless terminal operation.

13. The wireless communication system of claim 11, wherein the first operational mode corresponds to wireless terminal operation using frequency division duplex communication and the second operational mode corresponds to wireless terminal operation using time division duplex communication.

14. The wireless communication system of claim 11, wherein the first wireless communication numerology includes a first fast fourier transform (“FFT”) size and a first cyclic prefix (“CP”) value and the second wireless communication numerology includes second FFT size and a second CP value, at least one of the first FFT size and the second FFT size, and the first CP value and the second CP value being different.

15. The wireless communication system of claim 11, wherein communication in the first operational mode and the second operational mode use a same primary broadcast (“pBCH”) channel.

16. The wireless communication system of claim 15, wherein communication in the first operational mode and the second operational mode use different secondary broadcast (“sBCH”) channels.

17. The wireless communication system of claim 11, wherein a frame structure for wireless communication in the first operational mode is the same as the frame structure for wireless communication in the second operational mode.

18. The wireless communication system of claim 11, wherein a sampling frequency for communication in the first operational mode is the same as the sampling frequency for communication in the second operational mode.

19. The wireless communication system of claim 11, wherein the first operational mode is a time division duplex (“TDD”) mode having a first downlink to uplink transmission ratio and the second operational mode is a time division duplex mode having a second downlink to uplink transmission ratio, a TDD frame duration being the same for operation in the first operational mode and the second operational mode.

20. A method for wireless communication using a time division duplex (“TDD”) frame having a plurality of TDD slots for TDD communication, the method comprising:
arranging the plurality of TDD slots into uplink TDD slots and downlink TDD slots, the TDD frame having a synchronous transmission period in which the boundaries of downlink transmission and uplink transmission TDD slots are aligned among base stations and an asynchronous transmission period; and
selecting, for transmission during the asynchronous transmission period, a type of TDD uplink and downlink transmission slot arrangement from all available channel allocation schemes.
